(19) United States
(12) Patent Application Publication
(10) Pub. No.: US 2024/0129895 A1
(43) Pub. Date: Apr. 18, 2024

(54) AVOIDING LOSING NETWORK ACCESS DUE TO LACK OF NAVIGATION SYSTEM COVERAGE

(71) Applicant: Telefonaktiebolaget LM Ericsson (publ), Stockhoim (SE)

(72) Inventors: Johan RUNE, Lidingö (SE); Emre YAVUZ, Stockholm (SE); Sebastian EULER, Storvreta (SE); Xingqin Lin, San Josè, CA (US); Talha KHAN, Santa Clara, CA (US); Zhipeng LIN, Nanjing, Jiangsu (CN); Helka-Liina MÄÄTTÄNAN, Espoo (FI)

(73) Assignee: Telefonaktiebolaget LM Ericsson (publ), Stockhoim (SE)

(21) Appl. No.: 18/277,448

(22) PCT Filed: Feb. 17, 2022
(86) PCT No.: PCT/IB22/51433

§ 371 Date: Aug. 16, 2023

Related U.S. Application Data
(60) Provisional application No. 63/151,365, filed on Feb. 19, 2021.
(60) Provisional application No. 63/151,373, filed on Feb. 19, 2021.

(51) Int. Cl. H04W 68/00; H04W 36/08; H04W 36/32; H04W 76/20

(52) U.S. Cl. CPC H04W 68/005; H04W 36/08; H04W 36/322; H04W 76/20; H04W 84/06

(57) ABSTRACT

A method performed by a user equipment, UE, is provided. The method comprises detecting that the UE has lost navigation system coverage partially or wholly. The method further comprises, after the detection, transmitting towards a network node a loss notification indicating that the UE has the lost navigation system coverage.

### TECHNICAL FIELD

This disclosure relates to methods and systems for avoiding losing network access due to lack of navigation system coverage.

### BACKGROUND

In Third Generation Partnership Project (3GPP) Release 8, the Evolved Packet System (EPS) was described. The EPS is based at least in part on the Long Term Evolution (LTE, also referred to as 4G) radio network and the Evolved Packet Core (EPC). EPC was originally intended to provide voice and mobile broadband (MBB) services but has continuously evolved to broaden its functionality. Since 3GPP Release 13, Narrowband Internet of Things (NB-IoT) and LTE-Machine Type Communication (LTE-M) are part of the LTE specifications and provide connectivity to massive machine type communications (mMTC) services.

In 3GPP Release 15, a release of the 5^{th} Generation (5G) system (5GS) was described. This radio access technology is intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification/standard and also define new components for new use cases. One such component is the introduction of a framework for beam forming and beam management to extend the support of the 3GPP technologies to a frequency range going beyond 6 GHz.

NR Non-Terrestrial Networks (NTNs)

In 3GPP Release 15, 3GPP described preparing NR for operation in a Non-Terrestrial Network (NTN). Research was performed within the study item “NR to support Non-Terrestrial Networks” and resulted in Technical Report (TR) 38.811. In 3GPP Release 16, research to prepare NR for operation in an NTN network continued with the study item “Solutions for NR to support Non-Terrestrial Network” and resulted in TR 38.821. Meanwhile, the interest to adapt NB-IoT and LTE-M for operation in NTN continued to grow. 3GPP Release 17 contains both a work item on NR NTN and a study item on NB-IoT and LTE-M support for NTN.

A satellite radio access network usually includes the following components: a satellite and an earth-based gateway that connects the satellite to a base station or a core network, depending on the choice of architecture. The link between the gateway and the satellite is referred to as a “feeder” link and the link between the satellite and UE is referred to as an “access” link.

Depending on the orbit altitude, a satellite may be categorized as a low earth orbit (LEO) satellite, a medium earth orbit (MEO) satellite, or a geostationary earth orbit (GEO) satellite. An LEO satellite may be at a height ranging from 250-1,500 km with orbital periods ranging from 90-120 minutes. An MEO satellite may be at a height ranging from 5,000-25,000 km with orbital periods ranging from 3-15 hours. A GEO satellite may be at a height about 35,786 km with an orbital period of 24 hours.

A communication satellite may generate several beams over a given area. The footprint of a beam is usually in an elliptic shape, which has been traditionally considered as a cell. The footprint of a beam is also often referred to as a spotbeam. The footprint of a beam may move over the earth surface with the satellite movement or may be fixed with some beam pointing mechanism used by the satellite to compensate for its motion. The size of the spotbeam depends on the system design and may range from tens of kilometers to a few thousands of kilometers.

A transparent payload architecture and a regenerative payload architecture have been considered. In a transparent payload architecture (also referred to as a bent pipe architecture), a base station (e.g., a gNodeB (gNB)) is located on the ground and the satellite forwards signals/data between the base station and a UE. The base station (e.g., gNB) may be integrated in the gateway or connected to the gateway via a terrestrial connection (e.g., wire, optic fiber, or wireless link). In a regenerative payload, the base station (e.g., gNB) is located in the satellite. In the work item for NR NTN in 3GPP Release 17, only the transparent payload/bent pipe architecture is considered.

Propagation delay is one aspect of satellite communications that is different from the delay expected in a terrestrial mobile system. For example, for a bent pipe satellite network, the round-trip delay may, due to the orbit height, range from tens of milliseconds (ms) for LEO to several hundreds of ms for GEO. This can be compared to the round-trip delays in a cellular network which are generally limited to 1 ms. In the satellite communications, the propagation delay may also be highly variable due to the high velocity of the LEO and MEO satellites and change in the order of 10 to 100 microseconds (μs) every second, depending on the orbit altitude and satellite velocity.

In the context of propagation delay, the timing advance (TA) the UE uses for its uplink transmissions may be much greater than in terrestrial networks in order for the uplink and downlink to be time aligned at the gNB, as is the case in NR and LTE. One of the purposes of the random access (RA) procedure is to provide the UE with a valid TA (which the network later can adjust based on the reception timing of uplink transmission from the UE).

However, even the random access preamble (e.g., the initial message from the UE in the random access procedure) may have to be transmitted with a timing advance to allow a reasonable size of the RA preamble reception window in the gNB, but this TA may not have to be as accurate as the TA the UE subsequently uses for other uplink transmissions. The TA the UE uses for the RA preamble transmission may be called the “pre-compensation TA.” Various proposals are considered for how to determine the pre-compensation TA, all of which involve information originating both at the gNB and at the UE.

The discussed alternative proposals include broadcast of a common TA, which is valid at a certain reference point (e.g., a center point in the cell). The UE would then calculate how its own pre-compensation TA deviates from the common TA, based on the difference between the UE's own location and the reference point together with the position of the satellite. Herein, the UE acquires its own position using GNSS measurements, and the UE obtains the satellite position using satellite orbital data (including satellite position at a certain time) broadcast by the network.

The discussed alternative proposals include the UE autonomously calculating the propagation delay between the UE and the satellite, based on the respective positions of the UE and the satellite, and the network/gNB broadcasting the propagation delay on the feeder link, which may be the propagation delay between the gNB and the satellite. Herein, the UE acquires its own position using GNSS measurements, and the UE obtains the satellite position using satellite orbital data (including satellite position at a certain time) broadcast by the network. The pre-compensation TA is then twice the sum of the propagation delay on the feeder link and the propagation delay between the satellite and the UE.

The discussed alternative proposals include the gNB broadcasting a timestamp (in System Information Block (SIB) #9 (SIB9)), which the UE compares with a reference timestamp acquired from GNSS. Based on the difference between these two timestamps, the UE can calculate the propagation delay between the gNB and the UE, and the pre-compensation TA is twice as long as this propagation delay.

A second aspect closely related to the timing is a Doppler frequency offset induced by the motion of the satellite. The access link may be exposed to Doppler shift in the order of 10-100 kilohertz (kHz) in sub-6 gigahertz (GHz) frequency band and proportionally higher in higher frequency bands. Also, the Doppler shift is varying with a rate of up to several hundred Hz per second in the S-band (from 2 to 4 GHz) and several kHz per second in the Ka-band (from 26.5 to 40 GHz).

Global Navigation Satellite System

A Global Navigation Satellite System (GNSS) comprises a set of satellites orbiting the earth in orbits crossing each other such that the orbits are distributed around the globe. The satellites transmit signals and data that allow a receiving device on earth to accurately determine time and frequency references and accurately determine its position provided that signals are received from a sufficient number of satellites (e.g., four satellites). The position accuracy may typically be in the range of a few meters, but using averaging over multiple measurements, a stationary device may achieve much better accuracy.

A well-known example of a GNSS is the American Global Positioning System (GPS). Other examples are the Russian Global Navigation Satellite System (GLONASS), the Chinese BeiDou Navigation Satellite System, and the European Galileo.

The transmissions from GNSS satellites include signals that a receiving device uses to determine the distance to the satellite. By receiving such signals from multiple satellites, the device can determine its position. However, this requires that the device also knows the positions of the satellites. To enable this, the GNSS satellites also transmit data about their own orbits (from which its position at a certain time can be derived). In a Global Positioning System (GPS), such information is referred to as ephemeris data and almanac data (or sometimes lumped together under the term navigation information).

The time required to perform a GNSS measurement (e.g., a GPS measurement) may vary widely, depending on the circumstances, mainly depending on the status of the ephemeris and almanac data the measuring devices have previously acquired (if any). In the worst case, a GPS measurement can take several minutes. GPS uses a bit rate of 50 bits per second (bps) for transmitting its navigation information. The transmission of the GPS date, time, and ephemeris information takes 90 seconds. Acquiring the GPS almanac containing orbital information for all satellites in the GPS constellation takes more than 10 minutes. If a UE already possesses this information, the synchronization to the GPS signal for acquiring the UE position and Coordinated Universal Time (UTC) is a significantly faster procedure.

3GPP NTN Dependence of GNSS

To handle the timing and frequency synchronization in a NR or LTE based NTN, one technique is to equip each device with a Global Navigation Satellite System (GNSS) receiver. The GNSS receiver allows a device to estimate its geographical position. In one example, an NTN gNB carried by a satellite broadcasts its ephemeris data (e.g., data about the satellite's position, velocity, and orbit) to a GNSS equipped user equipment (UE). The UE can then determine the propagation delay, the delay variation rate, the Doppler shift, and its variation rate based on its own location (obtained through GNSS measurements) and the satellite location and movement (derived from the ephemeris data).

The GNSS receiver also allows a device to determine a time reference (e.g., in terms of Coordinated Universal Time (UTC)) and frequency reference. This can also be used to handle the timing and frequency synchronization in a NR or LTE based NTN. In a second example, a NTN gNB carried by a satellite broadcasts its timing (e.g., in terms of a Coordinated Universal Time (UTC) timestamp) to a GNSS equipped UE. The UE can then determine the propagation delay, the delay variation rate, the Doppler shift, and its variation rate based on its time/frequency reference (obtained through GNSS measurements) and the satellite timing and transmit frequency. The UE may use this knowledge to compensate its UL transmissions for the propagation delay and Doppler effect.

The 3GPP Release 17 Study Item Description (SID) on NB-IoT and LTE-M for NTN states that: “GNSS capability in the UE is taken as a working assumption in this study for both NB-IoT and eMTC devices. With this assumption, UE can estimate and pre-compensate timing and frequency offset with sufficient accuracy for UL transmission. Simultaneous GNSS and NTN NB-IoT/eMTC operation is not assumed.” Furthermore, in the NTN work item and Internet of Things (IoT) NTN study item for 3GPP Release 17, GNSS capability is assumed. That is, it is assumed that an NTN capable UE is also GNSS capable, and operation of the NTN relies on GNSS measurements at the UEs.

### SUMMARY

Certain challenges presently exist. For instance, the NTN work item for 3GPP release 17 assumes that the NTN capable UEs are GNSS capable and GNSS measurements at the UEs are essential for the operation of the NTN. GNSS signals, however, are weak and for proper UE positioning, UEs must receive signals from multiple GNSS satellites. As a consequence, there may be situations where an NTN UE temporarily loses proper GNSS coverage. This may occur, for example, when the UE is inside a building or in a train moving at a high speed.

During the periods of the UE's temporary loss of GNSS coverage, the UE may not be able to function properly in the NTN and the NTN may not be able to provide the services normally provided to the UE. In particular, due to the lack of proper GNSS coverage, the UE may not be able to perform autonomous timing advance (TA) and Doppler shift frequency pre-compensation based on GNSS measurements, and thus may lose the ability to access the NTN.

In order to solve the problem described above, in one aspect, there is provided a method performed by a network node. The method comprises receiving a loss notification indicating that a user equipment, UE, has lost navigation system coverage partially or wholly, wherein the notification was transmitted by the UE. The method further comprises, based at least on receiving the loss notification, either (i) keeping the UE in a state in which the UE is capable of transmitting towards the network node a regain notification indicating that the UE has regained the navigation system coverage or (ii) initiating a handover procedure to handover the UE.

In another aspect, there is provided a method performed by a user equipment, UE. The method comprises detecting that the UE has lost navigation system coverage partially or wholly, and after the detection, transmitting towards a network node a loss notification indicating that the UE has the lost navigation system coverage.

In another aspect, there is provided a computer program comprising instructions which when executed by processing circuitry cause the processing circuitry to perform the method described above.

In another aspect, there is provided a network node. The network node is configured to receive a loss notification indicating that a user equipment, UE, has lost navigation system coverage partially or wholly, wherein the notification was transmitted by the UE. The network node is further configured to, based at least on receiving the loss notification, either (i) keep the UE in a state in which the UE is capable of transmitting towards the network node a regain notification indicating that the UE has regained the navigation system coverage or (ii) initiate a handover procedure to handover the UE.

In another aspect, there is provided a user equipment, UE. The user equipment is configured to detect that the UE has lost navigation system coverage partially or wholly, and after the detection, transmit towards a network node a loss notification indicating that the UE has the lost navigation system coverage.

In another aspect, there is provided an apparatus. The apparatus comprises a memory, and processing circuitry coupled to the memory. The apparatus is configured to perform the method described above.

### BRIEF DESCRIPTION OF THE DRAWINGS

The accompanying drawings, which are incorporated herein and form part of the specification, illustrate various embodiments.

FIG. 1 shows an exemplary system according to some embodiments.

FIG. 2 shows a process according to some embodiments.

FIG. 3 shows a process according to some embodiments.

FIG. 4 is a block diagram of a UE according to some embodiments.

FIG. 5 is a block diagram of a network node according to some embodiments.

### DETAILED DESCRIPTION

Although embodiments are described below mainly in terms of New Radio (NR) based Non-Terrestrial Networks (NTNs), the embodiments are equally applicable to an NTN based on Long Term Evolution (LTE) technology or any other network requiring a Global Navigation Satellite System (GNSS) capability and support in a terminal device (such as a network involved in high speed train (HST) scenarios).

In this disclosure, “loss of GNSS coverage” (or “lack of GNSS coverage” or “lost GNSS coverage”) may be defined by an UE being unable to use GNSS to determine any one or more of: (i) its own position, (ii) an accurate time reference, and/or (iii) an accurate frequency reference. That is, in this disclosure, loss of or lack of GNSS coverage may be defined as loss or lack of any combination of inability of the UE to use GNSS to determine its position, inability to use GNSS to determine an accurate time reference, and/or inability to use GNSS to determine an accurate frequency reference.

In this disclosure, the term “user equipment” or “UE” may refer to any type of wireless device communicating with a network node and/or with another UE in a cellular or mobile communication system. Examples of UEs include, but are not limited to, a target device, a device to device (D2D) UE, a vehicular to vehicular (V2V) UE, a machine type UE, a machine type communication (MTC) UE, a UE capable of machine to machine (M2M) communication, a PDA, a Tablet, a mobile terminal, a smart phone, laptop embedded equipment (LEE), laptop mounted equipment (LME), and USB dongles.

In this disclosure, the term “network” may be used to refer to a network node, which may be a base station such as a gNB (e.g., in an NR based NTN) or an evolved Node B (eNB) (e.g., in an LTE based NTN), an access point in another type of network, or any other network node with the ability to communicate with a UE. Examples of network nodes include, but are not limited to, a NodeB, a base station (BS), a multi-standard radio (MSR) radio node such as a MSR BS, an eNodeB, a gNodeB, a Master eNB (MeNB), a Secondary eNB (SeNB), an integrated access backhaul (IAB) node, a network controller, a radio network controller (RNC), a base station controller (BSC), a relay, donor node controlling relay, a base transceiver station (BTS), a Central Unit (e.g. in a gNB), a Distributed Unit (e.g. in a gNB), a Baseband Unit, a Centralized Baseband, C-RAN, am access point (AP), transmission points, transmission nodes, remote radio unit (RRU), remote radio head (RRH), nodes in distributed antenna system (DAS), a core network node (e.g. mobile switching center (MSC), mobile management entity (MME), etc.), operation and management (O&M), operation support systems (OSS), self-organizing network (SON), positioning node (e.g. evolved serving mobile location centre (E-SMLC)).

In this disclosure, transmission of a random access preamble (or a random access preamble transmission) may be a Physical Random Access Channel (PRACH) transmission (because a random access preamble may be transmitted on the PRACH).

In this disclosure, the term “preamble” may be used as short for “random access preamble.”

In this disclosure, the terms “pre-compensation TA,” “pre-compensation TA value,” “TA pre-compensation,” and “TA compensation” (and sometimes “TA” and “Timing Advance”) are used interchangeably.

In this disclosure, the terms “pre-compensation frequency adjustment,” “pre-compensation frequency adjustment value,” “frequency adjustment pre-compensation,” “frequency pre-compensation,” “frequency pre-compensation adjustment,” and “frequency adjustment” are used interchangeably.

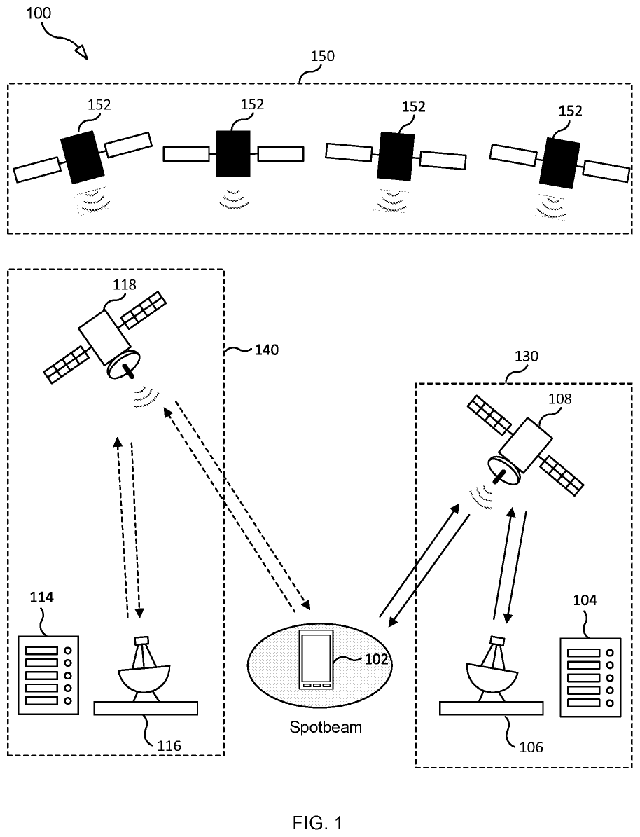

FIG. 1 shows an exemplary system 100 according to some embodiments. System 100 comprises a user equipment (UE) 102, a first satellite radio access network (RAN) 130, a second satellite RAN 140, and GNSS 150.

First satellite RAN 130 comprises a first base station (BS) (or a core network) 104, a first gateway (GW) 106, and a first satellite 108. First GW 106 is configured to connect first satellite 108 to first BS 104. When UE 102 is connected to first satellite RAN 130, UE 102 transmits/receives data to/from first BS 104 via first GW 106 and first satellite 108.

Similarly, second satellite RAN 140 may comprise a second BS (or a core network) 114, a second GW 116, and a second satellite 118. Like first GW 106, second GW 116 is configured to connect second satellite 118 to second BS 114. Like first satellite RAN 130, when UE 102 is connected to second satellite RAN 140, UE 102 transmits/receives data to/from second BS 114 via second GW 116 and second satellite 118.

The link between first gateway 106 and first satellite 108 is referred as a feeder link and the link between first satellite 108 and UE 102 is referred as an access link. Similarly, the link between second gateway 116 and second satellite 118 is referred as a feeder link and the link between second satellite 118 and UE 102 is referred as an access link.

As shown in FIG. 1, in system 100, second satellite 118 is configured to orbit at a layer that is higher than the layer at which first satellite 108 is configured to orbit. In one example, first satellite 108 is an LEO satellite and second satellite 118 is an MEO satellite or an GEO satellite. In another example, first satellite 108 may be an MEO satellite and second satellite 118 may be an GEO satellite.

GNSS 150 comprises navigation satellites 152. Navigation satellites 152 are configured to transmit navigation signals. UE 102 is configured to receive the navigation signals and, based on the received navigation signals, determine one or more of time reference, frequency reference, and its position.

The numbers of UE(s), RANs, satellites, GWs, and BSs (or core networks) shown in FIG. 1 are provided for illustration purpose only and do not limit the embodiments of this disclosure in any way.

Reporting Loss and/or Regaining of GNSS Coverage

In some embodiments, UE 102's loss of GNSS coverage (which may be temporary or permanent) may be reported to a network node (e.g., network node 104) to which UE 102 is connected (especially in case UE 102 is in the Radio Resource Control (RRC) Connected (RRC_CONNECTED) state). In the RRC_CONNECTED state, UE 102 is capable of signalling occurrences of events (e.g., loss and/or regaining of GNSS coverage) to network node 104 (at least as long as UE 102 has a valid timing advance, e.g., while its time alignment timer is running)a

UE 102 may transmit towards network node 104 an indication indicating that UE 102 has lost the GNSS coverage. In response to receiving the indication, network node 104 may take measures to mitigate the problems caused by UE 102's loss of GNSS coverage. In some embodiments, the existing signalling mechanism in NTN may be extended to allow UE 102 to transmit the indication. For example, a new RRC message may be used to deliver the indication of UE 102's loss of GNSS coverage from UE 102 to network node 104. In another example, a new Medium Access Control (MAC) Control Element (CE) may be sent at the MAC layer to indicate UE 102's loss of GNSS coverage.

In some embodiments, a mechanism allowing UE 102 to signal loss of GNSS coverage to network node 104 may be complemented with a mechanism allowing UE 102 to signal UE 102's regaining of GNSS coverage. For example, an RRC message may be used to deliver the indication of UE 102's regaining of GNSS coverage from UE 102 to network node 104. More specifically, in one example, a pair of new RRC messages may be used: one for signalling loss of GNSS coverage and one for signalling regaining of GNSS coverage.

In other embodiments, the same RRC message may be used for signalling both events—signalling loss of GNSS coverage and signalling regaining of GNSS coverage. In such embodiments, the RRC message may include one or more message parameters indicating which type of event (loss of GNSS coverage or regaining GNSS coverage) has occurred.

In some embodiments (e.g., the embodiments in which loss of GNSS coverage is signalled using a MAC CE), a MAC CE may be used to signal UE 102's regaining of GNSS coverage. For example, a pair of new MAC CEs may provided: one for signalling loss of GNSS coverage and one for signalling regaining of GNSS coverage.

In other embodiments, the same MAC CE may be used for signalling both events—signalling loss of GNSS coverage and signalling regaining of GNSS coverage. In those embodiments in which the same MAC CE is used for signalling both events, the MAC CE may include one or more parameters indicating which type of event (loss of GNSS coverage or regaining GNSS coverage) has occurred.

In other embodiments, Uplink Control Information (UCI) signalling may be used for signalling loss or regaining of GNSS coverage from UE 102 to network node 104. The UCI signal may be transmitted on the Physical Uplink Control Channel (PUCCH) or the Physical Uplink Shared Channel (PUSCH).

Keeping UE in the RRC_CONNECTED State

In some embodiments, in case UE 102 is in the bRRC_CONNECTED state, after UE 102 has reported to network node 104 UE 102's loss of GNSS coverage, network node 104 may initiate a process of keeping UE 102 in RRC_CONNECTED state. The process may include network node 104 not releasing UE 102 to an RRC_INACTIVE or RRC_IDLE state even if UE 102 is inactive for a significant period of time (e.g., the elapsed time that would normally trigger release of UE 102 to an RRC_INACTIVE or RRC_IDLE state because of expiration of an inactivity timer).

If UE 102 is released to an RRC_IDLE or RRC_INACTIVE state, UE 102 may be unreachable until it regains its GNSS measurements because UE 102 would not be able to respond to a paging without the leverage of GNSS to calculate a pre-compensation TA and/or pre-compensation frequency adjustment. Thus, by keeping UE 102 in the RRC_CONNECTED state, UE 102 can be reachable by network node 104 even after UE 102 has lost the GNSS coverage.

In some embodiments, instead of signalling the mere indication of loss or regaining of GNSS coverage, UE 102 may provide to network 104 more detailed information regarding UE 102's GNSS coverage. The detailed information is described below.

Maintaining UE's Valid TA

In some embodiments, after receiving the indication that UE 102 has lost its GNSS coverage, network node 104 may instruct UE 102 to maintain a valid TA by transmitting dummy packets to network node 104 if too long time elapses since the last “real” transmission. In such embodiments, UE 102 is configured to transmit dummy packets in response to receiving the indication.

Network node 104 may use the reception of these dummy packets to determine whether UE 102's TA needs to be updated and then signal suitable TA modification instructions to UE 102 in case UE 102's TA needs to be updated. Network node 104 may signal suitable TA modification instructions, for example, using a Timing Advance Command MAC CE, an Absolute Timing Advance MAC CE, or a new MAC CE for timing advance adjustments specially designed for NTN (possibly with different MAC CEs for different types of NTN, e.g., NTNs using LEO satellites, GEO satellites, and/or High Altitude Platform Stations (HAPSs)). That is, in some embodiments, to prevent UE 102's time alignment timer from expiring (which would result in an invalid TA), UE 102 may transmit a “real” or dummy packets before UE 102's time alignment timer expires.

In some embodiments, instead of transmitting a dummy packet, UE 102 may transmit towards network node 104 a random access preamble (even when UE 102's TA is still valid), and network node 104 may modify UE 102's TA in the Random Access Response message. As an additional option, network node 104 may provide UE 102 with a dedicated random access preamble (e.g., a contention-free preamble) when network node 104 instructs UE 102 to maintain a valid TA in this manner.

In some embodiments, a dummy packet may, for example, be a MAC Packet Data Unit (PDU) containing a Buffer Status Report MAC CE. In some embodiments, UE 102 may be configured to (through signalling or standard specification) to transmit dummy packets with a certain margin before the expiration of UE 102's time alignment timer. Such margin may allow time for UE 102 to send Hybrid Automatic Repeat reQuest (HARQ) feedback to the transmission(s) network node 104 uses to provide the TA modification instruction while UE 102's TA is still valid (e.g., so that the HARQ feedback can be transmitted before the time alignment timer expires at UE 102).

UE 102 may be allowed to send a HARQ feedback even if its time alignment timer has expired in this particular situation (e.g., when transmitting HARQ feedback on downlink transmission(s) coming from network node 104 after UE 102 has sent a dummy packet).

In case the transmission of the dummy packet is a Physical Downlink Shared Channel (PDSCH) transmission, the dummy packet may be preceded by a scheduling request, which may serve the purpose of requesting network node 104 (e.g., gNB) to allocate uplink (UL) transmission resources for UE 102 such that the UL transmission resources may be used for transmission of the dummy packet.

In some embodiments, in addition to utilizing the PDSCH transmission for transmitting the dummy packets, network node 104 (e.g., gNB) may utilize the received scheduling request itself for estimation of the UE's transmission timing error/offset. In some embodiments, the scheduling request may be a part of the dummy transmission.

In some embodiments, network node 104 may not make UE 102 responsible for taking actions to prevent UE 102's time alignment timer from expiring (e.g., by UE 102 transmitting towards network node 104 a dummy packet such as a Buffer Status Report MAC CE or by transmitting a random access preamble). For example, network node 104 (e.g., a gNB) may keep track of UE 102's time alignment timer and sends towards UE 102 an UL grant (e.g., a resource assignment for UL transmission) without having received a preceding scheduling request from UE 102.

If UE 102 receives an UL grant and does not have any “real” data to transmit, UE 102 may transmit a Buffer Status Report MAC CE or a dummy packet, which may be predefined (e.g., standardized) for this purpose. In some embodiments, the Downlink Control Information (DCI) containing the UL grant may include information indicating that UE 102 is obliged to utilize the UL grant for transmission even if UE 102 does not have any data pending for UL transmission. In some embodiments, instead of sending a regular UL grant, network node 104 may request or configure UE 102 to transmit a Sounding Reference Signal (SRS).

Keeping UE's Frequency Adjustment Valid

In some embodiments, similar functionality may be employed to prevent UE 102's frequency error/offset from becoming too large. In some embodiments, this may, for example, involve a separate timer governing the frequency adjustment validity or a common timer for TA validity and frequency adjustment validity.

In those embodiments in which similar functionality is used for the TA control and the frequency adjustment control, UE 102 may use different types of UL transmissions depending on whether the trigger for the transmission is coming invalidation of UE 102's TA or a coming invalidation of UE 102's frequency adjustment or both (e.g., if a common timer is used for controlling TA validity and frequency adjustment validity). In some embodiments, a way of delegating the responsibility to UE 102 may be used in relation to frequency adjustments (e.g., if a separate timer governing the validity of the UE's frequency adjustment is used).

In some embodiments, like the TA control described above, an UL grant may be used to prevent UE 102's frequency error/offset from becoming too large (e.g., by preventing that a frequency adjustment timer expires). Thus, in some embodiments, network node 104 (e.g., gNB) may use the uplink transmission resulting from the UL grant to determine UE 102's UL transmission frequency error/offset, and network node 104 may signal an appropriate frequency adjustment modification instruction to UE 102.

In some embodiments in which an UL grant is used both for TA and frequency adjustment control, the DCI containing the UL grant may contain an indication of which of the TA and frequency adjustment control is the reason for the transmission of the UL grant. This indication may trigger UE 102 to perform different UL transmissions (e.g., different information, bit sequences or signals, such as reference signals or similar). Such an indication making UE 102 to transmit a certain type of UL transmission may also be an explicit indication of the type of UL transmission for which UE 102 should use the allocated UL transmission resources.

In some embodiments, instead of sending an UL grant to UE 102 (or triggering SRS transmission), network node 104 (e.g., a gNB) may transmit a PDCCH order to UE 102 before UE 102's time alignment timer expires. The PDCCH order may be a DCI sent on the PDCCH. In response to receiving the PDCCH order, UE 102 may be triggered to initiate a random access procedure. For this purpose, the PDCCH order DCI may contain a dedicated random access preamble for UE 102 to use in the ordered random access procedure.

In some embodiments, network node 104 may send the PDCCH order with a sufficient time margin, so that UE 102 has sufficient time to receive and parse the PDCCH order and transmit a random access in an available PRACH occasion before the UE's time alignment timer expires. In some alternative embodiments, network node 104 may send the PDCCH order later, not allowing enough time for UE 102 to initiate the random access before its time alignment timer expires, but still allowing sufficient time that UE 102 can be assumed to transmit (e.g., using an estimated pre-compensation TA) the random access preamble with a timing error small enough to keep it within the gNB's reception window (e.g., it will be covered by one of the timing hypotheses the gNB uses for random access preamble detection).

Network node 104 may use a larger random access preamble reception window (e.g., using a greater number of timing hypotheses in the preamble detection), thereby allowing even later transmission of the PDCCH order. In some embodiments, even if a valid timing advance can still be regained, allowing the UE's time alignment timer to expire in a way (e.g., with additional time elapsing) that UE 102 cannot be assumed to be able to estimate a good enough pre-compensation TA means that UE 102 may not be able to initiate an UL transmission (e.g. by transmitting a scheduling request) until a PDCCH ordered random access with extended random access reception window has been performed.

In some embodiments, all of the above embodiments describing the methods to allow UE 102 to maintain (or regain) a valid TA may additionally or alternatively be used to make UE 102 maintain (or regain) valid frequency adjustment (e.g., Doppler shift compensation) for its UL transmissions. In some embodiments, the “real” or dummy transmission or random access preamble from UE 102 may be used by network node 104 to determine whether UE 102's UL frequency needs to be updated and then signal suitable UL frequency adjustment modification instructions to UE 102 (e.g., using a MAC CE command or a DCI). In some embodiments, to maintain a valid pre-compensation frequency adjustment, network node 104 may trigger UE 102 to transmit SRS from time to time (e.g., when UE 102's time alignment timer is about to expire or based on another timer used for controlling frequency compensation/adjustment procedures).

Based on the received SRS, network node 104 may estimate needed pre-compensation frequency adjustment and send adjustment command to UE 102. In some embodiments, the SRS transmission may facilitate network node 104 to estimate TA besides frequency adjustment. In some embodiments, the same MAC CE or DCI may be used for sending both TA and frequency adjustment commands to UE 102. The possible usage of a DCI for this purpose and the properties of this DCI are further described below.

In the above embodiments, UE 102's time alignment timer and its expiration (or imminent expiration or soon to come expiration) govern the timing of controlling and/or updating UE 102's TA, and thus govern when to take preventive actions (such as UL dummy transmissions or PDCCH ordered random access). However, in some embodiments, UE 102's TA may be allowed to expire as long as it is assessed that UE 102 still has a good enough estimate of its position or a good enough clock/time reference to calculate an accurate enough pre-compensation TA for random access preamble transmission. These embodiments allow a longer time to elapse without TA control/update. In some embodiments, a special inactivity timer may be used for determining the length of time to elapse without the TA control/update.

In some embodiments, upon receiving an indication that UE 102 has lost GNSS coverage, network node 104 may configure UE 102 to transmit a random access preamble (possibly with a limited set of PRACH resources or dedicated PRACH resources) even if UE 102 cannot expect that its estimated pre-compensation TA will be accurate enough for a regular random access preamble transmission.

In order to configure UE 102 in such way, network node 104 (e.g., gNB) may use a larger random access preamble reception window when UE 102's time alignment timer has expired and possibly some more time has elapsed (e.g., using greater guard times before and after the ideal preamble arrival time and using more timing hypotheses in the preamble detection).

In some embodiments, if a limited or dedicated set of PRACH resources are indicated for this purpose, the larger preamble reception window may be employed only for these PRACH resources. In some embodiments, network node 104 (e.g., gNB) may use a larger random access preamble reception window the longer time that elapses after the expiration of the UE's time alignment timer, thereby anticipating that the uncertainty (e.g., lack of accuracy) of the UE's pre-compensation TA estimate increase with time. In some embodiments, similar means may be applied to extend the time UE 102 may go without having its transmission frequency adjustment/compensation adjusted.

In some embodiments, similar to UE 102's time alignment timer, a frequency alignment timer may be used to govern when UE 102's UL frequency has to be controlled and possibly updated and may hence govern when preventive actions should be taken. In some embodiments, UE 102's UL frequency alignment timer may be allowed to expire as long as UE 102 can still calculate an accurate enough pre-compensation frequency adjustment for random access preamble transmission. Some of these embodiments may allow a longer time to elapse without frequency adjustment control/update, and, optionally, a special (inactivity) timer may be introduced for this purpose.

Signalling Refined Information Regarding UE 102's GNSS Coverage

In some embodiments, the signalling of loss and/or regaining of GNSS coverage may be refined to include more details to provide more information to network node 104. Thus, in some embodiments, UE 102 may signal one or more of the following:

(1) The consequence(s) of the current suboptimal (or lack of) GNSS availability. The consequence(s) may include: Inability to perform position measurements; inability to acquire a GNSS clock reference; inability to acquire a GNSS frequency reference; any combination of two or more of the inabilities above; and partial inability to perform position measurements (e.g., UE 102 being able to perform position measurements but without normal GNSS accuracy (the inaccuracy may differ in different directions)). The indication of the partial inability to perform position measurement may include an estimated accuracy of the position measurements UE 102 is able to perform. The partial inability to perform position measurement may be combined with inability to acquire a GNSS clock reference and/or inability to acquire a GNSS frequency reference.

(2) The number of GNSS satellites from which UE 102 can receive signals. In some embodiments, in addition to the number of the GNSS satellites, UE 102 may also report the received signal strength per GNSS satellite.

(3) The age of the latest GNSS position measurement. This age may be complemented with an estimate of how well the latest GNSS position measurement can be trusted (e.g., its estimated accuracy such as, for example, in the form of a radius around the position). UE 102 may use internal sensors (e.g., accelerometers) when estimating the accuracy or only base it on elapsed time (e.g., possibly complemented by experience of how much UE 102's position typically change during a certain period of time). In addition to the estimate, UE 102 may also report the estimated change of the estimated accuracy as a function of time.

(4) The age of the latest clock reference retrieved from GNSS. This age may be complemented by an estimate of how accurate the latest clock reference can be assumed to be in UE 102. UE 102 may determine the estimate based on known typical drift of its internal clock. In addition to the estimate, UE 102 may also report the estimated change of the estimated accuracy as a function of time.

(5) The age of the latest frequency reference retrieved from GNSS. This age may be complemented by an estimate of how accurate the latest frequency reference can be assumed to be in UE 102. UE 102 may determine the estimate based on known typical drift of its internal oscillator. In addition to the estimate, UE 102 may also report the estimated change of the estimated accuracy as a function of time.

(6) An estimate/forecast of how long the situation—where UE 102 does not have the GNSS coverage will persist. UE 102 may base the estimate on GNSS navigation data (e.g., ephemeris and almanac data), which may provide information about the GNSS satellites' orbits and current positions and velocities.

(7) An amount of time UE 102 wants to be kept in the RRC_CONNECTED state (e.g., expecting that GNSS coverage will return shortly). In some scenarios, because the RRC_CONNECTED state entails higher energy consumption for UE 102, UE 102 may prefer not being kept in the RRC_CONNECTED state indefinitely if GNSS coverage does not return as expected. Thus, UE 102 may instead prefer to accept loss of NTN connectivity and wait for the GNSS coverage to return. Thus, if UE 102 signals loss of GNSS coverage, UE 102 may also signal a maximum time period during which UE 102 wishes to be kept in RRC_CONNECTED state. If UE 102 does not regain the GNSS coverage even after the maximum time period, network node 104 may release UE 102 to the RRC_IDLE or RRC_INACTIVE state.

(8) Which method UE 102 prefers to use for keeping time adjustment and/or frequency adjustment without GNSS coverage (e.g., dummy PUSCH transmission or a special random access method to address UE 102's lacking of proper pre-compensation TA and/or frequency adjustment (to compensate for Doppler shift)).

In this disclosure, the signalling of refined information regarding UE 102's GNSS coverage or refined GNSS availability state information may be referred to as “GNSS readiness mode.” In its simplest form, the GNSS readiness mode may be predefined in standard specification with N indexed categories and UE 102 may simply send an index of the category that matches UE 102's state the most in terms of GNSS availability (e.g., number of available satellites, ability or inability to determine UE 102's position, clock reference and/or frequency reference and (when applicable) estimated accuracy thereof, or, in terms of when UE 102 expects it has full GNSS accuracy available).

The categories may be defined by time estimates that may be the most essential information network node 104 needs to know about UE 102's GNSS availability. In some embodiments, the categories may be defined by accuracy estimates as well as time estimates. In other embodiments, the categories may be separately defined by the accuracy estimates and UE 102 may signal a combination of the two. In some embodiments, any other property or aspect related to GNSS availability may be categorized (and indexed) (e.g., number of satellites, ability or inability to determine position, clock reference, and/or frequency reference).

In some embodiments, UE 102 may update network node 104 whenever the previously signaled GNSS availability (or ability) related information has changed, possibly triggered only by “significant” changes. In some embodiments, what change is considered “significant” may depend on the type of signaled information. The type of signaled information comprises any one or more of the followings: a change in the number of satellites UE 102 can receive signals from, a change in one or more received signal strength(s) larger than a certain size, a change in one or more received signal strength(s) such that the signal strength(s) exceed(s) a certain threshold value, a change in one or more received signal strength(s) such that the signal strength(s) go(es) below a certain threshold value, a change in the estimated accuracy of the position measurements UE 102 is able to perform, and/or a change in the set of GNSS “services” that are available to UE 102 such as, for example, a change in the combination of above described inabilities (regarding position measurements, clock reference acquisition, and frequency reference acquisition).

In some embodiments, network node 104 may configure UE 102 (or request UE 102) to send updates when changes in previously signaled GNSS related information occur. In some embodiments, the configuration/request may identify the condition(s) (e.g., the “significant” change(s)) that trigger UE 102 to send the update(s). In some embodiments, network node 104 may provide this configuration/request in a message acknowledging reception of signaled GNSS related information (e.g., of the types described in this application).

In some embodiments, the GNSS coverage loss can be implicitly indicated from UE 102. For example, when network node 104 (e.g., a gNB) receives dummy data in a normal PUSCH, network node 104 may know that UE 102 has lost the GNSS coverage. This dummy packet may also be used for maintaining TA and/or frequency adjustment, such as, for example, when a time alignment timer (or a timer governing frequency adjustments) is close to expire. In some embodiments, that the time is close to expire may be defined as, for example, the time when the time to time alignment timer expiry (or frequency adjustment timer expiry) is smaller than a predetermined threshold. In some embodiments, the dummy transmission may have properties making it more suitable for network node 104 to determine proper TA and/or frequency adjustments for UE 102. The dummy transmission may, for example, contain one or more reference signal(s) designed for such purposes.

GNSS Coverage Loss PUSCH

As discussed above, as an alternative to transmitting the dummy packet on regular PUSCH resources, UE 102 may transmit the dummy packet on a channel specially designed depending on the time/frequency accuracy expected to be estimated from the reception processing of this channel. This channel may be called “dummy PUSCH” or GNSS Coverage Loss (GCL) PUSCH. The GCL PUSCH may be designed with one or more of the followings:

(1) A guard period in the beginning and/or the end of this channel in the time domain. This may be used for UEs without a valid TA. The dummy data symbols may also be treated as a guard period (e.g., when they are just reserved symbols).

(2) Demodulation Reference Signal (DMRS) configuration different from regular PUSCH (e.g., PUSCH as designed in NR Release 15/Release16). Zero (or one or more) OFDM symbols are for DMRS in the regular PUSCH. In some embodiments, the density (number of Orthogonal Frequency Division Multiplexing (OFDM) symbols) and/or the position of the DMRS in GCL PUSCH may be different than the density and/or the position of the DMRS in regular PUSCH.

(3) One or more properties that enhance the GCL PUSCH transmissions as means for determining the UE's timing and/or frequency error (e.g., to provide TA and/or frequency adjustment modification instruction(s) to UE 102). The one or more properties may involve extended cyclic prefix, scrambling, and/or DMRS. In some embodiments, the one or more properties may be specially designed for improved detection and estimation of timing and/or frequency offset/error.

(4) A duration of the GCL PUSCH that is across multiple slots.

(5) A guard band at both ends of the scheduled frequency resource.

(6) The frequency resource may be sub-Physical Resource Block (PRB) (e.g., for a deployment that may have a high number of UEs having GNSS loss).

(7) The Radio Network Temporary Identifier (RNTI) used for GCL PUSCH, which may be denoted GCL-RNTI, may be a new RNTI different from the Cell RNTI (C-RNTI), if available, and the RNTI (e.g., GCL-RNTI or C-RNTI) may differentiate uplink scheduling for a dummy packet and uplink scheduling for a normal packet.

DCI for Timing and/or Frequency Adjustment Instructions

In any of the embodiments described above in which Downlink Control Information (DCI) is used for conveying timing and/or frequency adjustment, the DCI used for timing and/or frequency adjustment may have a new DCI format or a DCI format existing in NR Release 15/Release 16 (e.g., a DCI format that utilizes reserved bits). In some embodiments, the DCI format may be combined with the use of a new RNTI (e.g., a GCL-RNTI as described above) for addressing transmissions of the DCI. In some embodiments, the DCI's Cyclic Redundancy Check (CRC) may be scrambled with the new RNTI.

In some embodiments, the DCI size of a new DCI format for TA command and/or frequency adjustment command transmission may be signaled by higher layer. In some embodiments, a new DCI Format 2_7 may be introduced for indication of the TA and/or frequency adjustment information. In some embodiments, DCI format 2_7 may be used for notifying the TA and/or frequency adjustment information for one or more UEs (e.g., one or more UEs out of GNSS coverage). The following information may be transmitted by means of the DCI format 2_7 with CRC scrambled by GCL-RNTI: block number 1, block number 2, . . . , block number N. The starting position of a block may be determined by the parameter gcl-PositionDCI-2-7 (or similar parameter(s) serving the same purpose) provided by higher layers (e.g. RRC) for UE 102 configured with the block(s).

If UE 102 is configured with higher layer parameter GCL-RNTI and dci-Format-2-7 (or similar parameters serving the same purpose), one block may be configured for UE 102 by higher layers, with one or more of the following fields defined for the block: (1) Timing Advance Command (This field may indicate the TA index value used to control the amount of timing adjustment that the MAC entity has to apply. The size of the field may be, for example, 12 bits); and (2) Frequency Adjustment Command (This field may indicate the frequency adjustment index value used to control the amount of frequency adjustment that the MAC entity has to apply. The size of the field may be, for example, 12 bits.).

In some embodiments, the size of DCI format 2_7 may be indicated by the higher layer parameter sizeDCI-2-7 (or a similar parameter serving the same purpose). In some embodiments, both sizeDCI-2-7 and gcl-PositionDCI-2-7 may be included in the dci-Format-2-7 IE.

In some embodiments, the timing to apply the TA command and/or frequency adjustment command signaled in the DCI may be determined by: (i) the PDCCH processing time, which may, for example, be assumed to be 0 ms, (ii) the PUSCH and/or PUCCH preparation time, (iii) the maximum or minimum timing advance value that can be provided by a TA command field, (iv) a MAC processing time (e.g., a constant time of 0.5 ms), (v) a configured or standardized time period after the PDCCH transmission, and/or (vi) a configured or standardized time period after the PDCCH reception. In some embodiments, because there will be no PDSCH processing time, the TA command in DCI compared to TA command on PDSCH may be applied in a shorter time after the reception of the TA command.

Handover of UE 102 in the RRC_Connected State

In some embodiments, in case UE 102 is in the RRC_Connected state when network node 104 (e.g., a base station or other network node) is informed about the loss of GNSS coverage for UE 102, network node 104 may perform a handover of UE 102 from its current serving cell (e.g., RAN 130) to a target cell (e.g. a cell served by a different satellite or a cell belonging to a terrestrial network) (e.g., RAN 140) that has less stringent timing/frequency pre-compensation requirements (i.e. requirement on the accuracy of a UE's timing advance (TA) pre-compensation and/or Doppler shift frequency pre-compensation), e.g. a cell belonging to another type of NTN system or a cell belonging to a terrestrial network.

Similarly, if network node 104 determines that UE 102 in the RRC_CONNECTED state has regained GNSS coverage, network node 104 may perform a handover of UE 102 to another cell regardless of the timing/frequency pre-compensation requirements posed by the cell (e.g. depending on the satellite serving the concerned cell). For instance, when UE 102 regains GNSS coverage, it may be beneficial to return UE 102 to the cell/network it was connected in when the GNSS coverage was lost. The rationale for this is that this network was probably chosen because it was the most beneficial for one reason or the other in the first place.

In one example, LEO satellites feature large Doppler shift and Doppler shift variation rates which require UEs to determine the UE-specific Doppler shift and perform frequent frequency pre-compensation adjustments. On the other hand, GEO satellites have a negligible Doppler shift which typically does not require UE-specific pre-compensation. Thus, if a UE served by a LEO satellite has inaccurate/stale GNSS measurement, the network may perform a handover to a cell served by a GEO satellite. In another example, when a UE is detected to have lost the GNSS capability, it can be handed over to a terrestrial network.

After the handover to a new less demanding cell (e.g., in another NTN system or a terrestrial network and/or another RAT), UE 102's loss of GNSS coverage may not be a problem, since the network and UE 102 can operate independently of GNSS coverage. Otherwise, if GNSS support is still needed, any of the following measures may be taken.

To avoid that UE 102 is left without a valid TA (and with a potentially invalid frequency adjustment value) due to the expiration of UE 102's TA timer, network node 104 may instruct UE 102 to maintain a valid TA (and/or valid frequency adjustment value) by triggering UE 102 to transmit dummy packets if the time gap between “real” transmissions is too wide (i.e., triggering the UE to transmit dummy packets before the TA timer expires).

As discussed above, network node 104 can use the reception of these dummy packets to determine whether UE 102's TA (or possibly frequency adjustment) needs to be updated and then signal suitable TA modification instructions (and/or possibly frequency adjustment modification instruction) to the UE, e.g., using a Timing Advance Command MAC CE (and/or a possible new MAC CE for modification of a UE's frequency adjustment).

As an alternative to dummy packet transmissions in the uplink, the network may use PDCCH orders to trigger the UE to initiate a random access procedure, which involves modification of the UE's TA (and/or possibly frequency adjustment) if needed.

In case UE 102 is in the RRC_INACTIVE or RRC_IDLE state, when UE 102 detects loss of GNSS coverage, if UE 102 still has previously obtained GNSS measurement data that is fresh enough to allow determination of a pre-compensation TA (and pre-compensation frequency adjustment) accurate enough for random access preamble transmission, UE 102 may connect to network node 104 to report its loss of GNSS coverage and the network may then choose to apply the above described measures to keep UE 102 in the RRC_CONNECTED state.

Regardless of the availability of the additional measures discussed above, however, the decreased timing/frequency pre-compensation requirements may delay the need for such actions and may also decrease the frequency with which some actions need to be employed.

In another embodiment, extending or complementing the above embodiments, network node 104 may configure UE 102 for a conditional handover to a cell with looser requirements on timing/frequency pre-compensation (assumedly in another NTN system or in a terrestrial network and maybe with another RAT), with the condition(s) for handover execution including at least that UE 102 has lost GNSS coverage, possibly complemented by other conditions such as that the GNSS support has been lost for a certain time and/or that the channel quality of the target cell, e.g. in terms of RSRP or RSRQ exceeds one or more threshold(s).

There are different ways for network node 104 to configure UE 102 to perform the conditional handover when UE 102 needs to perform the handover. For example, network node 104 may transmit to UE 102 a command for configuring UE 102 to perform the conditional handover. In one example, the configuring command may be included in any of known messages used for establishing a communication between UE 102 and network node 104. In another example, the configuring command may be included in a separate message that is just for serving the function of configuring UE 102 to perform the conditional handover. In some embodiments, UE 102 may be pre-configured (e.g., using a SIM) to perform the conditional handover.

In another embodiment, once network node 104 is informed about the partial or full loss of GNSS coverage, UE 102's timing advance may be updated by network node 104, if needed/observed by network node 104, using the Timing Advance Command MAC CE or some other similar means via dedicated signaling, e.g., in MAC or RRC layers. This may be achieved using the existing value range by providing updates frequently enough so that UE 102's timing advance is kept up to date. In an alternative, the value range may be extended so that less frequent updates would be enough to keep UE 102's timing advance up to date.

In some embodiments, UE 102 may be configured with how to report the loss of GNSS coverage and whether network node 104 wants to receive this signalling from UE 102. That is, if network node 104 knows that in certain cells it cannot move UE 102 to other cells with different requirements, or no terrestrial network is available, it is not beneficial to receive such reports. This query may be specified as a UERequest-UEResponse message pair such that network node 104 may poll UE 102 on its current “GNSS readiness” or “GNSS availability” state.

Optionally, UE 102 may be allowed to include this information in a UEAssistanceInformation message. Whether UE 102 is allowed to include this indication may be configurable and/or may depend on network type, information provided in system information, or be part of the ephemeris data. It may also be that UE 102 is configured to include this information piggypagged to RRM measurement reports that may be event based RSRP/RSRQ or location reporting or periodic reporting. The details on which report UE 102 may or shall, or shall if available, include the information on GNSS availability in may be configured in the measurement related configuration, e.g., in the MeasConfig IE, the measurement object, e.g., the MeasObjectNR IE, the MeasId IE, or the ReportConfigNR IE.

Handling Loss of GNSS Coverage for UEs in the RRC_INACTIVE and/or RRC_IDLE State

UE 102 in the RRC_INACTIVE or RRC_IDLE state may need to be able to determine its position or acquire an accurate GNSS clock/time reference and/or an accurate frequency reference in order to access an NTN because, without it, UE 102 may not be to calculate a pre-compensation TA and/or pre-compensation frequency adjustment to be used when transmitting the random access preamble. Hence, when UE 102 in the RRC_INACTIVE or RRC_IDLE state loses GNSS coverage, UE 102 may become unable to access the network for UE 102's initiated communication and may also be unable to respond to paging from network node 104. In essence, communication to and from UE 102 may be prohibited (except for one-way communication from network node 104 such as broadcast information from network node 104).

Thus, in some embodiments, UE 102 may be allowed to or may be configured to (e.g., through the broadcast system information or using parameters in a dedicated RRCRelease message) try to avoid ending up in such a non-communicable situation when UE 102 detects loss of sufficient GNSS coverage. For example, when UE 102 in the RRC_INACTIVE or RRC_IDLE state detects loss of sufficient GNSS coverage, UE 102 may check whether its most recently acquired GNSS related data is still fresh enough or can be assumed to be accurate enough to allow UE 102 to determine a pre-compensation TA and/or pre-compensation frequency adjustment that is/are accurate and reliable enough for transmission of a random access preamble.

If UE 102 determines that this is the case, UE 102 may transmit a random access preamble to network node 104 to initiate a random access procedure to access the network. In some embodiments, once UE 102 is connected to the NTN, UE 102 may signal its GNSS status (e.g., lack of sufficient GNSS coverage) to network node 104. In some embodiments, network node 104 may then choose to apply the means for keeping UE 102 in the RRC_CONNECTED state (e.g., as described above). In some embodiments, UE 102 may determine the pre-compensation TA and/or pre-compensation frequency adjustment through other means. Such means include:
(1) Using a UE position estimate (e.g., combined with the satellite position and/or feeder link delay and/or combined with a common TA reference point and the common TA defined/signaled for that reference point) based on an outdated or semi-outdated GNSS position measurement combined with subsequent movement tracking using internal accelerometers;
(2) Using a UE position estimate obtained through network based positioning means in a terrestrial network, which may be combined with subsequent movement tracking using internal accelerometers;
(3) Using a UE position based on a received cell identity (ID) (e.g., a cell global identity (CGI) or a physical cell identity (PCI)) in a terrestrial network (e.g., NR or LTE);
(4) Using a UE position based on a received Wireless Local Area Network (WLAN) Service Set Identifier (SSID) and/or Bluetooth beacon;
(5) Using a UE position estimate based on fingerprinting of received signals (e.g., in terms of a set of received cell ID(s) and/or WLAN SSID(s) and possibly their respective signal strengths); and/or
(6) Using a recently acquired TA and/or a frequency adjustment while UE 102 was still in the RRC_CONNECTED state in the concerned NTN cell, which, in some embodiments, may include modifying the recently acquired TA and/or frequency adjustment based on estimated satellite movement (e.g., based on satellite ephemeris data), UE movement, and/or the elapsed time.

In some embodiments, when an estimated UE position is used to determine an accurate enough pre-compensation TA and/or pre-compensation frequency adjustment, the calculation of the pre-compensation TA and/or pre-compensation frequency adjustment may depend on the UE position, the satellite position, the Gateway (GW)/gNB position (on the ground), the feeder link delay, and/or a “common TA” (signaled from network node 104) with associated reference point.

In some embodiments, network node 104 (e.g., a gNB) may configure (e.g., using the broadcast system information or dedicated signalling, such as an RRCRelease message) a limit on the estimated uncertainty of the UE's estimated pre-compensation TA and/or frequency adjustment for UE 102 to be allowed to initiate a random access procedure towards network node 104. In some embodiments, network node 104 may configure a limit on the estimated uncertainty of estimated pre-compensation TA uncertainty or configure only a limit on the estimated uncertainty of the estimated pre-compensation frequency adjustment or configure limits on both the estimated uncertainty of the estimated pre-compensation TA and the estimated uncertainty of the estimated pre-compensation frequency adjustment. In some embodiments, in order for UE 102 to be allowed to initiate a random access procedure, neither the estimated uncertainty of the estimated pre-compensation TA nor the estimated uncertainty of the estimated pre-compensation frequency adjustment may be greater than any associated limit.

In some embodiments, when UE 102 cannot calculate a pre-compensation TA or pre-compensation frequency adjustment or a combination thereof, UE 102 may not initiate access to the network. In some embodiments, network node 104 may configure a dedicated time-frequency resource (and/or special channel or signal) for UE 102 to signal loss of GNSS coverage using a special channel or signal. For example, when UE 102 cannot calculate a pre-compensation TA or pre-compensation frequency adjustment or a combination thereof, UE 102 may signal loss of GNSS coverage using the dedicated time-frequency resource and/or special channel or signal.

In some embodiments, network node 104 may attempt to receive the special channel or signal over a large time window and/or frequency range covering the configured dedicated time-frequency resource. Network node 104 may configure the dedicated time-frequency resource (and/or special channel or signal) for UE 102, when UE 102 is in the RRC_CONNECTED state. In some embodiments, network node 104 may do this as a general proactive precaution. In some embodiments, the decision to do so may also be based on additional information. The addition information may be any one or a combination of the followings:
(1) An indication from UE 102 that it sometimes or frequently loses GNSS coverage;
(2) Capability information from UE 102 indicating that loss of GNSS coverage may occur more frequently than for an average UE (e.g., based on an indication of a simple GNSS receiver);
(3) An indication from UE 102 that UE 102 has reason to believe that it will soon lose GNSS coverage (e.g., based on GNSS navigation information (including GNSS satellite ephemeris data) or based on experience); and/or
(4) The network's previous experience of the UE's GNSS availability status.

According to some embodiments, UE 102 in the RRC_IDLE or RRC_INACTIVE state may autonomously take a similar action involving movements to a less demanding cell (in terms of timing/frequency pre-compensation) to improve its chances to subsequently enter the RRC_CONNECTED state without fresh GNSS measurement data. That is, UE 102 may re-select to a cell with less stringent timing/frequency pre-compensation requirements, e.g., a cell belonging to another type of NTN system or a cell belonging to a terrestrial network (and maybe with another RAT).

For example, UE 102 in the RRC_IDLE or RRC_INACTIVE state may perform a random access procedure. In a variant of this embodiment, the information on timing/frequency pre-compensation requirement is provided in the system information or may be part of pre-provided ephemeris information which may be preconfigured (e.g. on the USIM) or received over NAS signaling.

If network access in the new cell is not always be possible without GNSS coverage/support, UE 102 may initiate a random access process in the new cell before the accuracy of UE 102's estimated timing advance and/or Doppler shift frequency adjustment pre-compensation(s) becomes too poor for network access. Once in the RRC_CONNECTED state, the network node 104 and the UE 102 may employ the actions discussed above (e.g., sending a dummy packet or performing a random access procedure).

In any case, by re-selecting to the less demanding cell, UE 102 increases its chances to access the network and enter the RRC_CONNECTED state before its GNSS measurement data which UE 102's TA pre-compensation and Doppler shift frequency pre-compensation are based on becomes too outdated to allow accurate enough pre-compensation values to be calculated.

It may even be the case that when UE 102 loses GNSS coverage, its latest GNSS measurements data are already too old to allow network access in the current cell and re-selecting to a less demanding cell is UE 102's only chance to enter the RRC_CONNECTED state (to be able to communicate). Also even if actions to handle UE 102's lack of GNSS coverage/support may still be needed in the new less demanding cell, the employment of these actions may be delayed and the frequency with which some actions need to be employed may be decreased.

As a further option, network node 104 may configure, e.g., in broadcast system information or in a dedicated message, such as an RRCRelease message, whether UE 102 should employ this cell re-selection strategy in case of loss of GNSS coverage. Network node 104 may also configure conditions for UE 102 to apply the cell re-selection strategy, e.g., in the form of channel quality thresholds (e.g. RSRP and/or RSRQ) and/or priorities for different network systems, RATs and/or carrier frequencies.

In another variant, the RRCRelease message may include information on timing/frequency pre-compensation requirements of neighbor cells or neighbor frequencies or RATs or NTN types. In yet another variant, this information about neighbor cells or neighbor frequencies or RATs or NTN types is provided in the system information or in pre-provided ephemeris information which may be preconfigured, e.g., in the USIM, or received over NAS.

In some embodiments, network node 104 may provide UE 102 with two Cell Reselection Priority lists indicating absolute priorities of network systems, RATs and/or carrier frequencies. The first Cell Reselection Priority list is built on the existing priority list that may give the priority order of different NR frequencies or inter-RAT frequencies, and is further enhanced with types of network systems which may include Terrestrial Network, LEO Network, MEO Network, GEO Network, HAPS Network, ATG Network in the ordering.

The second Cell Reselection Priority list is a new priority list that may give the priority order of different NR frequencies or inter-RAT frequencies or types of network systems (e.g., Terrestrial Network, LEO Network, MEO Network, GEO Network, HAPS Network, ATG Network). A reasonable configuration of the ordering in the second Cell Reselection Priority list would be that the frequency and/or RAT and/or network type that has less stringent time and frequency access requirement is configured to be of higher priority.

When UE 102 regains its GNSS coverage, UE 102 may perform the Cell reselection evaluation process using the configuration of the first Cell Reselection Priority list. On the other hand, when UE 102 loses its GNSS coverage, UE 102 may perform the Cell Reselection evaluation process using the configuration of the second Cell Reselection Priority list.

Configured Support for Loss of GNSS Coverage Signalling

In some embodiments, the feature by which UE 102 can signal loss of GNSS coverage and regaining of GNSS coverage and the means by which network node 104 keeps UE 102 which lacks sufficient GNSS coverage in the RRC_CONNECTED state may be configurable. In some embodiments, the configuration may be conveyed to UE 102 through the broadcast system information or using dedicated signalling such as RRC signalling or MAC signalling. The configuration may include, for example, whether UE 102 should signal loss of sufficient GNSS coverage and/or regaining of sufficient GNSS coverage and/or details about the GNSS availability (e.g., as described above). In some embodiments, the configuration may also include instructions targeting UEs in the RRC_INACTIVE or RRC_IDLE state (in which case the configuration may be conveyed using broadcast system information or a dedicated RRCRelease message or a dedicated or group-common DCI on the PDCCH).

Signalling of Predicted Loss of GNSS Coverage

In some embodiments, UE 102 may signal to network node 104 a prediction of change of GNSS availability, such as, for example, predicted time when UE 102 will lose sufficient GNSS coverage. In some embodiments, UE 102 may make such predictions based on GNSS navigation data (e.g., ephemeris and almanac data), which may provide information on the GNSS satellites' orbits, current positions, and/or velocities.

Discontinuous Reception (DRX) or Measurement Gaps for Checking GNSS Availability

In some embodiments, when UE 102 in the RRC_CONNECTED state has signaled that UE 102 has lost sufficient GNSS coverage and UE 102 is not able to measure/monitor GNSS signals simultaneously with communication in the NTN (e.g., based on signaled UE 102 capability information), network node 104 (e.g., an gNB) may configure UE 102 with DRX or Extended DRX (eDRX) or measurement gaps to allow UE 102 to repeatedly check if UE 102 has regained sufficient GNSS coverage (in which case UE 102 may report the regaining to network node 104).

Compensating for GNSS Coverage Loss for UE(s) in the RRC_CONNECTED State

There may be scenarios where it can be assumed that UE 102's location does not change enough during a time period during which UE 102 has temporarily lost the GNSS coverage to significantly impact the pre-compensation value(s) for TA and/or frequency adjustment (e.g., where, except for a negligible contribution from UE 102's movements, the change in the pre-compensation value(s) is caused by satellite movements which can be predicted based on satellite ephemeris data).

Even in such scenarios, UE 102 may still need UE position information with certain accuracy in the RRC_CONNECTED state to continue to check, for example, whether a location-based condition is fulfilled for a conditional handover. In some embodiments, UE 102 may notify network node 104 with an RRC or MAC signal about the temporary loss of GNSS coverage (as mentioned in the embodiments captured above) so that network node 104 may provide a TA value and some additional information (e.g., correspondingly in an RRC or MAC message), which may help UE 102 to compute the change in position with respect to the last observed one.

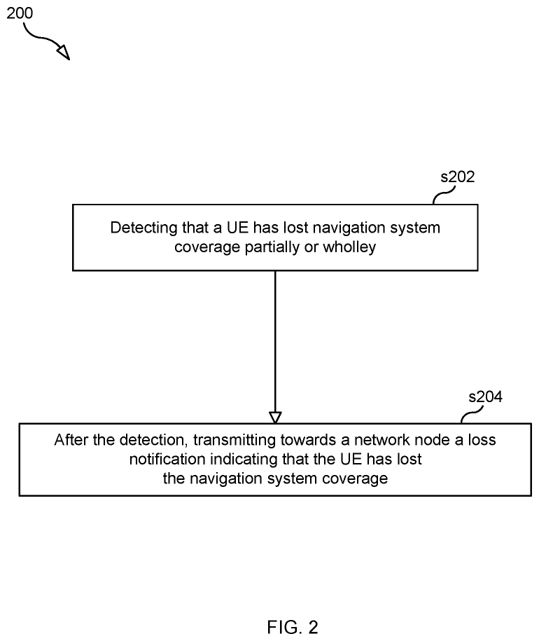

FIG. 2 shows a process 200 performed by UE 102 according to some embodiments.

Process 200 may begin with step s202. Step s202 comprises detecting that the UE has lost navigation system coverage partially or wholly. Step s204 comprises, after the detection, transmitting towards a network node a loss notification indicating that the UE has the lost navigation system coverage.

In some embodiments, the loss notification is transmitted via any one of (i) a radio resource control, RRC, signaling, (ii) a medium access control, MAC, control element, CE, signaling, or (iii) an uplink control information, UCI, signaling on a physical uplink control channel, PUCCH, or a physical uplink shared channel, PUSCH.

In some embodiments, the method further comprises receiving a command instructing the UE to transmit towards the network node a dummy packet or a random access preamble, wherein the command was transmitted by the network node; and after receiving the command but before a time alignment timer for the UE expires, transmitting towards the network node the dummy packet or the random access preamble.

In some embodiments, the method further comprises receiving one or more timing modification instructions; and using the received one or more timing modification instructions, modifying a TA of the UE. The one or more timing modification instructions were transmitted by the network node, and the one or more timing modification instructions were determined using at least the dummy packet or the random access preamble.

In some embodiments, the dummy packet is transmitted via a physical uplink shared channel, PUSCH. The PUSCH comprises any one or more of the followings: (i) a guard period in the beginning and/or the end of the PUSCH in a time domain; (ii) one or more orthogonal frequency-division multiplexing, OFDM, symbols for a demodulation reference signal, DMRS; (iii) a guard band at both ends of a scheduled frequency resource; and/or (iv) a radio network temporary identifier, RNTI, different from a cell RNTI.

In some embodiments, the method further comprises receiving (i) an uplink, UL, grant, (ii) a message triggering the UE to transmit a sounding reference signal, SRS, or (iii) a physical downlink control channel, PDCCH, order; and after the receiving but before the expiration of the time alignment timer for the UE, transmitting towards the network node the UL grant, the SRS, or the PDCCH order.

In some embodiments, the method further comprises transmitting an UL packet using the UL grant; and the UL packet is a dummy packet or a buffer status report medium access control, MAC, control element, CE.

In some embodiments, the method further comprises initiating a random access procedure based on receiving the PDCCH order.

In some embodiments, the loss notification indicates any one or more of the followings: (i) the UE's partial or full inability to perform position measurements; (ii) the UE's partial or full inability to acquire a global navigation satellite system, GNSS, clock reference; (iii) the UE's partial or full inability to acquire a GNSS frequency reference; (iv) a number of GNSS satellites from which the UE can receive navigation signals; (v) the age of the latest GNSS position measurement performed by the UE; (vi) the age of the latest clock reference retrieved from GNSS; or (vii) the age of the latest frequency reference retrieved from GNSS.

In some embodiments, the method further comprises as a result of detecting the loss of navigation system coverage, initiating a handover procedure or a cell re-selection procedure.

In some embodiments, the UE is configured to be in any one of the following states: (i) an active connection state; (ii) an inactive connection state, (iii) a disconnected state. In case the UE is in the inactive connection state or in the disconnected state at the time the UE detected that the UE has lost navigation system coverage partially or wholly, the UE is configured to initiate the cell re-selection procedure as a result of detecting the loss of navigation system coverage. The cell re-selection procedure comprises selecting from two or more cells a target cell based on one or more of (i) channel qualities of said two or more cells, (ii) a priority list of cells, and (iii) timing and/or frequency pre-compensation requirements of said two or more cells.

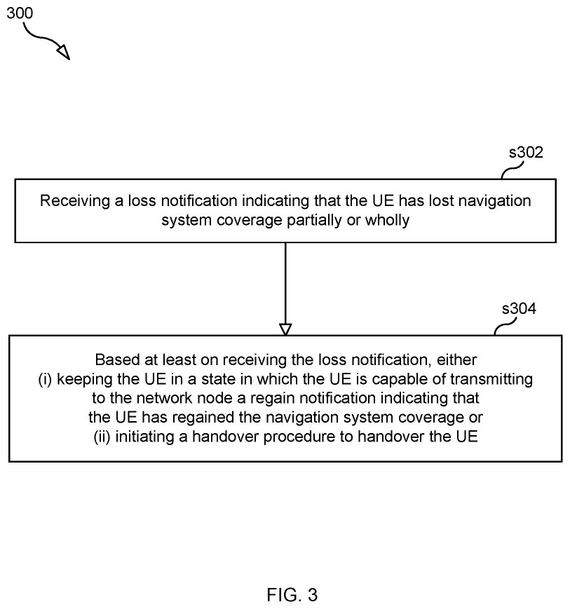

FIG. 3 shows a process 300 performed by network node 104 or 114 according to some embodiments. Process 300 may begin with step s302. Step s302 comprises receiving a loss notification indicating that a user equipment, UE, has lost navigation system coverage partially or wholly, wherein the notification was transmitted by the UE. Step s305 comprises, based at least on receiving the loss notification, either (i) keeping the UE in a state in which the UE is capable of transmitting towards the network node a regain notification indicating that the UE has regained the navigation system coverage or (ii) initiating a handover procedure to handover the UE.

In some embodiments, the loss notification is received at the network node via any one of a radio resource control, RRC, signaling, a medium access control, MAC, control element, CE, signaling, or an uplink control information, UCI, signaling on a physical uplink control channel, PUCCH, or a physical uplink shared channel, PUSCH.

In some embodiments, the state in which the UE is capable of transmitting towards the network node the regain notification is a radio resource control, RRC, connected, RRC_CONNECTED, state.

In some embodiments, keeping the UE in the RRC_CONNECTED state comprises refraining from releasing the UE to an RRC inactive, RRC_INACTIVE, state or an RRC idle, RRC_IDLE, state.

In some embodiments, the method further comprises based at least on receiving the loss notification, maintaining a valid timing advance, TA, for the UE.

In some embodiments, maintaining a valid TA for the UE comprises: instructing the UE to transmit towards the network node a dummy packet or a random access preamble; and after instructing the UE, receiving the dummy packet or the random access preamble transmitted by the UE, wherein the UE transmitted the dummy packet or the random access preamble before a time alignment timer for the UE expires.

In some embodiments, maintaining a valid TA for the UE further comprises: using at least the received dummy packet or the random access preamble to determine one or more timing modification instructions for the UE; and transmitting to the UE the one or more timing modification instructions. The one or more timing modification instructions are configured to cause the UE to modify the TA of the UE.

In some embodiments, the dummy packet is received via a physical uplink shared channel, PUSCH. The PUSCH comprises any one or more of the followings: (i) a guard period in the beginning and/or the end of the PUSCH in a time domain; (ii) one or more orthogonal frequency-division multiplexing, OFDM, symbols for a demodulation reference signal, DMRS; (iii) a guard band at both ends of a scheduled frequency resource; and/or (iv) a radio network temporary identifier, RNTI, different from a cell RNTI.

In some embodiments, maintaining a valid TA for the UE comprises: keeping track of a time alignment timer for the UE; and transmitting, before expiration of the time alignment timer for the UE, (i) an uplink, UL, grant, (ii) a message triggering the UE to transmit a sounding reference signal, SRS, or (iii) a physical downlink control channel, PDCCH, order.

In some embodiments, maintaining a valid TA for the UE further comprises receiving an UL packet transmitted by the UE. The UE transmitted the UL packet using the UL grant; and the UL packet is a dummy packet or a buffer status report medium access control, MAC, control element, CE.

In some embodiments, the PDCCH order is configured to trigger the UE to initiate a random access procedure.

In some embodiments, the loss notification indicates any one or more of the following: (i) the UE's partial or full inability to perform position measurements; (ii) the UE's partial or full inability to acquire a global navigation satellite system, GNSS, clock reference; (iii) the UE's partial or full inability to acquire a GNSS frequency reference; (iv) a number of GNSS satellites from which the UE can receive navigation signals; (v) an age of the latest GNSS position measurement performed by the UE; (vi) an age of the latest clock reference retrieved from GNSS; or (vii) an age of the latest frequency reference retrieved from GNSS.

In some embodiments, the handover of the UE comprises a handover of the UE from a first non-terrestrial network to a second non-terrestrial network. The first non-terrestrial network is provided by a first satellite orbiting at a first altitude. The second non-terrestrial network is provided by a second satellite orbiting at a second altitude; and the first altitude is lower than the second altitude.

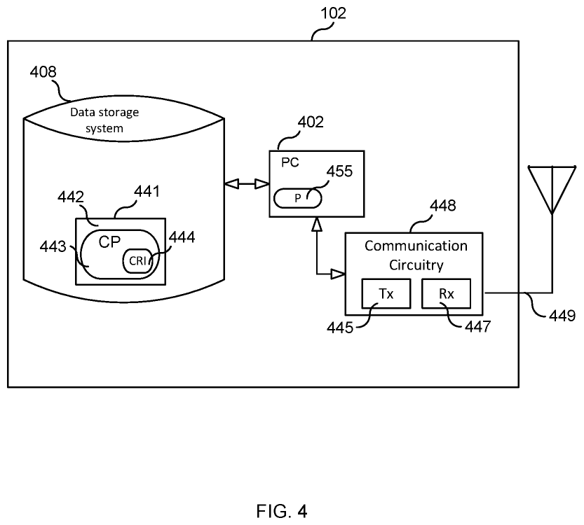

FIG. 4 is a block diagram of UE 102, according to some embodiments. As shown in FIG. 4, UE 102 may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like); communication circuitry 448, which is coupled to an antenna arrangement 449 comprising one or more antennas and which comprises a transmitter (Tx) 445 and a receiver (Rx) 447 for enabling UE 102 to transmit data and receive data (e.g., wirelessly transmit/receive data); and a local storage unit (a.k.a., “data storage system”) 408, which may include one or more non-volatile storage devices and/or one or more volatile storage devices. In embodiments where PC 402 includes a programmable processor, a computer program product (CPP) 441 may be provided. CPP 441 includes a computer readable medium (CRM) 442 storing a computer program (CP) 443 comprising computer readable instructions (CRI) 444. CRM 442 may be a non-transitory computer readable medium, such as, magnetic media (e.g., a hard disk), optical media, memory devices (e.g., random access memory, flash memory), and the like. In some embodiments, the CRI 444 of computer program 443 is configured such that when executed by PC 402, the CRI causes UE 102 to perform steps described herein (e.g., steps described herein with reference to the flow charts). In other embodiments, UE 102 may be configured to perform steps described herein without the need for code. That is, for example, PC 402 may consist merely of one or more ASICs. Hence, the features of the embodiments described herein may be implemented in hardware and/or software.

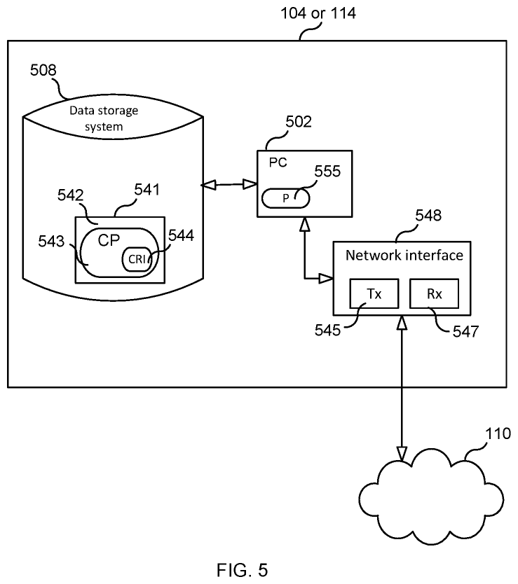

FIG. 5 is a block diagram of network node 104 or 114 (e.g., a base station such as gNB or eNB, or an access node), according to some embodiments, that can be used to implement any one of the network functions described herein. As shown in FIG. 5, network node 104 may comprise: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 104 may be a distributed computing apparatus); at least one network interface 548 (e.g., a physical interface or air interface) comprising a transmitter (Tx) 545 and a receiver (Rx) 547 for enabling network node 104 to transmit data to and receive data from other nodes connected to a network 110 (130 or 140) (e.g., an Internet Protocol (IP) network) to which network interface 548 is connected (physically or wirelessly) (e.g., network interface 548 may be coupled to an antenna arrangement comprising one or more antennas for enabling network node 104 to wirelessly transmit/receive data); and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes network node 104 to perform steps described herein (e.g., steps described herein with reference to the flow charts). In other embodiments, network node 104 may be configured to perform steps described herein without the need for code. That is, for example, PC 502 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-31. (canceled)

32. A user equipment, UE, comprising:
a memory; and
processing circuitry coupled to the memory, wherein the UE is configured to:
detect that the UE has lost navigation system coverage partially or wholly; and
after the detection, transmit towards a network node a loss notification indicating that the UE has the lost navigation system coverage.

33. The UE of claim 32, wherein the loss notification is transmitted via any one of (i) a radio resource control, RRC, signaling, (ii) a medium access control, MAC, control element, CE, signaling, or (iii) an uplink control information, UCI, signaling on a physical uplink control channel, PUCCH, or a physical uplink shared channel, PUSCH.

34. The UE of claim 32, wherein the UE is configured to:
receive a command instructing the UE to transmit towards the network node a dummy packet or a random access preamble, wherein the command was transmitted by the network node; and
after receiving the command but before a time alignment timer for the UE expires, transmit towards the network node the dummy packet or the random access preamble.

35. The UE of claim 34, wherein the UE is configured to:
receive one or more timing modification instructions; and
using the received one or more timing modification instructions, modify a TA of the UE, wherein
the one or more timing modification instructions were transmitted by the network node, and
the one or more timing modification instructions were determined using at least the dummy packet or the random access preamble.

36. The UE of claim 34, wherein
the dummy packet is transmitted via a physical uplink shared channel, PUSCH; and
the PUSCH comprises any one or more of the followings:
(i) a guard period in the beginning and/or the end of the PUSCH in a time domain;
(ii) one or more orthogonal frequency-division multiplexing, OFDM, symbols for a demodulation reference signal, DMRS;
(iii) a guard band at both ends of a scheduled frequency resource; and/or
(iv) a radio network temporary identifier, RNTI, different from a cell RNTI.

37. The UE of claim 34, wherein
the UE is configured to:
receive (i) an uplink, UL, grant, (ii) a message triggering the UE to transmit a sounding reference signal, SRS, or (iii) a physical downlink control channel, PDCCH, order; and
after the receiving but before the expiration of the time alignment timer for the UE, transmit towards the network node the UL grant, the SRS, or the PDCCH order, and
the UE is further configured to:
transmit an UL packet using the UL grant, wherein the UL packet is a dummy packet or a buffer status report medium access control, MAC, control element, CE, or
initiate a random access procedure based on receiving the PDCCH order.

38. The UE of claim 32, wherein the loss notification indicates any one or more of the followings:
(i) the UE's partial or full inability to perform position measurements;
(ii) the UE's partial or full inability to acquire a global navigation satellite system, GNSS, clock reference;
(iii) the UE's partial or full inability to acquire a GNSS frequency reference;
(iv) a number of GNSS satellites from which the UE can receive navigation signals;
(v) the age of the latest GNSS position measurement performed by the UE;
(vi) the age of the latest clock reference retrieved from GNSS; or
(vii) the age of the latest frequency reference retrieved from GNSS.

39. The UE of claim 32, wherein the UE is configured to:
as a result of detecting the loss of navigation system coverage, initiate a handover procedure or a cell re-selection procedure, wherein
the UE is configured to be in any one of the following states: (i) an active connection state; (ii) an inactive connection state, (iii) a disconnected state;
in case the UE is in the inactive connection state or in the disconnected state at the time the UE detected that the UE has lost navigation system coverage partially or wholly, the UE is configured to initiate the cell re-selection procedure as a result of detecting the loss of navigation system coverage; and
the cell re-selection procedure comprises selecting from two or more cells a target cell based on one or more of (i) channel qualities of said two or more cells, (ii) a priority list of cells, and (iii) timing and/or frequency pre-compensation requirements of said two or more cells.

40. A network node comprising:
a memory; and
processing circuitry coupled to the memory, wherein the network node is configured to:
receive a loss notification indicating that a user equipment, UE, has lost navigation system coverage partially or wholly, wherein the notification was transmitted by the UE; and
based at least on receiving the loss notification, either (i) keep the UE in a state in which the UE is capable of transmitting towards the network node a regain notification indicating that the UE has regained the navigation system coverage or (ii) initiate a handover procedure to handover the UE.

41. The network node of claim 40, wherein the loss notification is received at the network node via any one of a radio resource control, RRC, signaling, a medium access control, MAC, control element, CE, signaling, or an uplink control information, UCI, signaling on a physical uplink control channel, PUCCH, or a physical uplink shared channel, PUSCH.

42. The network node of claim 40, wherein
the state in which the UE is capable of transmitting towards the network node the regain notification is a radio resource control, RRC, connected, RRC_CONNECTED, state, and
keeping the UE in the RRC_CONNECTED state comprises refraining from releasing the UE to an RRC inactive, RRC_INACTIVE, state or an RRC idle, RRC_IDLE, state.

43. The network node of claim 40, wherein the network node is configured to, based at least on receiving the loss notification, maintain a valid timing advance, TA, for the UE, wherein maintaining a valid TA for the UE comprises:
instructing the UE to transmit towards the network node a dummy packet or a random access preamble; and
after instructing the UE, receiving the dummy packet or the random access preamble transmitted by the UE, wherein the UE transmitted the dummy packet or the random access preamble before a time alignment timer for the UE expires.

44. The network node of claim 43, wherein
maintaining a valid TA for the UE further comprises:
using at least the received dummy packet or the random access preamble to determine one or more timing modification instructions for the UE; and
transmitting to the UE the one or more timing modification instructions, and
the one or more timing modification instructions are configured to cause the UE to modify the TA of the UE.

45. The network node of claim 43, wherein
the dummy packet is received via a physical uplink shared channel, PUSCH; and
the PUSCH comprises any one or more of the followings:
(i) a guard period in the beginning and/or the end of the PUSCH in a time domain;
(ii) one or more orthogonal frequency-division multiplexing, OFDM, symbols for a demodulation reference signal, DMRS;
(iii) a guard band at both ends of a scheduled frequency resource; and/or
(iv) a radio network temporary identifier, RNTI, different from a cell RNTI.

46. The network node of claim 40, wherein the network node is configured to:
based at least on receiving the loss notification, maintain a valid timing advance, TA, for the UE, wherein maintaining a valid TA for the UE comprises:
keeping track of a time alignment timer for the UE; and
transmitting, before expiration of the time alignment timer for the UE, (i) an uplink, UL, grant, (ii) a message triggering the UE to transmit a sounding reference signal, SRS, or (iii) a physical downlink control channel, PDCCH, order.

47. The network node of claim 40, wherein
maintaining a valid TA for the UE further comprises receiving an UL packet transmitted by the UE;
the UE transmitted the UL packet using the UL grant;
the UL packet is a dummy packet or a buffer status report medium access control, MAC, control element, CE, and
the PDCCH order is configured to trigger the UE to initiate a random access procedure.

48. The network node of claim 40, wherein the loss notification indicates any one or more of the following:
(i) the UE's partial or full inability to perform position measurements;
(ii) the UE's partial or full inability to acquire a global navigation satellite system, GNSS, clock reference;
(iii) the UE's partial or full inability to acquire a GNSS frequency reference;
(iv) a number of GNSS satellites from which the UE can receive navigation signals;
(v) an age of the latest GNSS position measurement performed by the UE;
(vi) an age of the latest clock reference retrieved from GNSS; or
(vii) an age of the latest frequency reference retrieved from GNSS.

49. The network node of claim 40, wherein
the handover of the UE comprises a handover of the UE from a first non-terrestrial network to a second non-terrestrial network;
the first non-terrestrial network is provided by a first satellite orbiting at a first altitude;
the second non-terrestrial network is provided by a second satellite orbiting at a second altitude; and
the first altitude is lower than the second altitude.

50. A method performed by a user equipment, UE, the method comprising:
detecting that the UE has lost navigation system coverage partially or wholly; and
after the detection, transmitting towards a network node a loss notification indicating that the UE has the lost navigation system coverage.

51. A method performed by a network node, the method comprising:
receiving a loss notification indicating that a user equipment, UE, has lost navigation system coverage partially or wholly, wherein the notification was transmitted by the UE; and
based at least on receiving the loss notification, either (i) keeping the UE in a state in which the UE is capable of transmitting towards the network node a regain notification indicating that the UE has regained the navigation system coverage or (ii) initiating a handover procedure to handover the UE.
